(19) United States
(12) Patent Application Publication
(10) Pub. No.: US 2005/0004244 A1
(43) Pub. Date: Jan. 6, 2005

(54) Propylene-based resin foamed sheet and container made from the same

(75) Inventors: Satoshi Hanada, Ichihara-shi (JP); Shigefumi Takuno, Ichihara-shi (JP); Ryuma Kuroda, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/872,415

(22) Filed: Jun. 22, 2004

(30) Foreign Application Priority Data
Jun. 25, 2003 (JP) 2003-180644

(51) Int. Cl. C08J 9/18

(52) U.S. Cl. 521/142

(57) ABSTRACT

Disclosed is a propylene-based resin foamed sheet comprising a foamed layer formed of propylene-based resin and a non-foamed layer formed of a propylene-based resin that exhibits in its DSC measurement an endothermic curve that has a fusion peak which is the highest peak in the curve and which has a half-width ΔW of 15° C. or more and a container obtained by vacuum forming the propylene-based resin foamed sheet.

### BACKGROUND OF THE INVENTION

1. Field of the Invention

The present invention relates to propylene-based resin foamed sheets comprising a foamed layer formed of propylene-based resin and a non-foamed layer formed of propylene-based resin and to containers made from the sheets. Particularly, the present invention relates to polypropylene-based resin foamed sheets superior in secondary moldability such as vacuum formability and containers of superior appearance made from the propylene-based resin foamed sheets.

2. Description of the Related Art

Propylene-based resin sheets are superior in heat insulating property, light weight property, heat resistance and recyclability. Therefore, their demand as materials for containers for packaging foods or the like have been increased.

Generally, propylene-based resin sheets are molded into desired forms by vacuum forming and the like.

As an example of propylene-based resin foamed sheets, JP-A-5-208442 discloses a three-layer structure sheet in which non-foamed films are laminated on both sides of an intermediate foamed layer.

However, conventional propylene-based resin foamed sheets including the above-mentioned three-layer structure sheet can be fabricated successfully into containers only in a narrow processing temperature range. There is a difficulty in obtaining containers of good appearance from such conventional sheets.

### SUMMARY OF THE INVENTION

The inventors studied for developing a propylene-based resin foamed sheet from which containers of good appearance can be produced in a wide processing temperature range.

The present invention provides a propylene-based resin foamed sheet comprising a foamed layer formed of propylene-based resin and a non-foamed layer formed of a propylene-based resin that exhibits in its DSC measurement an endothermic curve that has a fusion peak which is the highest peak in the curve and which has a half-width ΔW of 15° C. or more. In one preferred embodiment, the foamed layer has on its each side a non-foamed layer formed of a propylene-based resin that exhibits in its DSC measurement an endothermic curve that has a fusion peak which is the highest peak in the curve and which has a half-width ΔW of 15° C. or more.

The present invention is directed also to a container obtained from the propylene-based resin foamed sheet mentioned above.

In the following description, regarding the essential non-foamed layer, “to be formed of a propylene-based resin that exhibits in its DSC measurement an endothermic curve that has a fusion peak which is the highest peak in the curve and which has a half-width ΔW of 15° C. or more” is defined as the DSC requirement. In other words, the essential non-foamed layer may be referred to as a “non-foamed layer satisfying the DSC requirement”.

### BRIEF DESCRIPTION OF THE DRAWINGS

FIG. 1 is a diagram showing one example of a machine for manufacturing a propylene-based resin foamed sheet of the invention.

FIG. 2 is a sectional view of one example of a circular die for use in the production of a propylene-based resin foamed sheet of the invention.

FIG. 3 is a diagram showing one example of an apparatus for vacuum forming a propylene-based resin foamed sheet of the invention.

FIG. 4 is a diagram showing one example of a method for determining the half-value width ΔW from an endothermic curve obtained by DSC measurement.

FIG. 5 is a diagram showing another example of a method for determining the half-value width ΔW from an endothermic curve obtained by DSC measurement.

### DETAILED DESCRIPTION OF THE PREFERRED EMBODIMENTS

The propylene-based resin foamed sheet of the present invention has a foamed layer formed of propylene-based resin. The foamed layer usually has an expansion ratio of from 1.5 to 40, preferably from 2 to 10. Because the expansion ratio of the foamed layer is adjusted within those ranges, the sheet of the present invention is superior in heat insulating property, light weight property and rigidity. The expansion ratio can be adjusted appropriately by varying the amount of a foaming agent used and physical conditions used during the sheet production.

The propylene-based resin which forms the foamed layer is selected from the group consisting of propylene homopolymer and propylene-based copolymer containing propylene-derived monomer units in an amount of 50 mol % or more. The propylene-based copolymer may be any of block copolymer, random copolymer and graft copolymer. Examples of propylene-based copolymers preferably employed include copolymers of ethylene and/or C₄₋₁₀ α-olefin with propylene. Examples of C₄₋₁₀ α-olefin include 1-butene, 4-methylpentene-1,1-hexene and 1-octene. The content of monomer units other than propylene-derived monomer units is preferably 15 mol % or less for ethylene, and 30 mol % or less for C₄₋₁₀ αa-olefin. As the propylene-based resin, only one kind of propylene-based resin may be used. Alternatively, a mixture of two or more kinds of propylene-based resin may also be employed.

Use of a long-chain branching propylene-based resin or a propylene-based resin having a weight average molecular weight of 1×10⁵ or more in an amount of 50% by weight or more based on the total amount of all the propylene-based resin is preferred because a propylene-based resin foamed sheet having a foamed layer having fine cells can be obtained.

Here, the long-chain branching polypropylene resin refers to a propylene-based resin having a branching index [A] within the range of from 0.20 to 0.98. One example of the long-chain branching polypropylene resin having a branching index with in the range of from 0.20 to 0.98 is a propylene available as PF-814 from Montell Technology Company.

The above-mentioned branching index [A] indicates the degree of branching of long chains and is defined by the following equation:
Branching index [A]=[η]Br/[η]Lin
wherein [η]Br indicates the intrinsic viscosity of the long-chain branching propylene-based resin and [η]Lin indicates the intrinsic viscosity of a linear propylene-based resin having repeating units and weight average molecular weight the same as those the long-chain branching propylene-based resin. The intrinsic viscosity depends particularly on the molecular weight and the degree of branching of a polymer. Accordingly, when the intrinsic viscosity of a long-chain branching polymer is compared to the intrinsic viscosity of a linear polymer having a weight average molecular weight the same as that of the long-chain branching polymer, the intrinsic viscosity serves as a measure for indicating the degree of branching of the long-chain branching polymer. The intrinsic viscosity of a propylene-based resin can be measured by use of a conventional method disclosed by Elliot et al. in J. Appl. Polym. Sci., 14, 2947-2963 (1970). For example, the intrinsic viscosity can be measured by dissolving a propylene-based resin in tetralin or o-dichlorobenzene, for example, at 135° C.

The weight average molecular weight (Mw) of a propylene-based resin can be measured by various methods, conventionally employed. Especially preferably used is a method disclosed by M. L. McConnel in American Laboratory, May, 63-75 (1978), namely, a low angle laser light scattering intensity measuring method.

Examples of the method for polymerizing the propylene-based resin having a weight average molecular weight of 1×10⁵ or more include a method in which a higher molecular weight component is polymerized first and then a lower molecular weight component is polymerized, as disclosed in U.S. Pat. No. 6,110,986, which is hereby incorporated by reference in its entirety and which corresponds to JP-A-11-228629.

Among the long-chain branching propylene-based resin and the propylene-based resin having a weight average molecular weight of 1×10⁵⁵ or more, a propylene-based resin having a uniaxial melt elongation viscosity ratio η₅/η_{0.1}, as measured under the conditions described later at a temperature about 30° C. higher than the melting point of the resin, of 5 or more is preferred. A propylene-based resin having a η₅/η_{0.1} ratio of 10 or more is more preferred. The uniaxial melt elongation viscosity ratio used herein is a value measured by means of a uniaxial melt elongation viscosity analyzer (e.g. a uniaxial melt elongation viscosity analyzer manufactured by Rheometrics Scientific, Inc.) at an elongation strain rate of 1 sec⁻¹. In the measurement, the uniaxial melt elongation viscosity detected at the time when 0.1 second has passed since strain was began is indicated by η_{0.1} and that detected at the time when 5 seconds has passed since strain was began is indicated by η₅. Use of a propylene-based resin having such a uniaxial melt elongation viscosity characteristic is preferred because a propylene-based resin foamed sheet having a foamed layer having fine cells can be obtained. As the propylene-based resin having a weight average molecular weight of 1×10⁵ or more, propylene-based resin having a weight average molecular weight of from 1×10⁵ to 5×10⁷ is more desirable.

The foamed layer in the sheet of the present invention may contain one or more thermoplastic resin other than propylene-based resin. Examples of such thermoplastic resin include olefin polymers other than propylene-based resin, ethylene-vinyl ester copolymers, ethylene-(meth)acrylic acid copolymers, ethylene-(meth)acrylic ester copolymers, polyester resins, polyamide resins, polystyrene resins, acrylic resins, acrylonitrile-based resins, polyvinyl alcohol and ionomer resins. Specific examples of the olefin polymers include homopolymers of olefin having 6 or less carbon atoms such as ethylene, butene, pentene and hexene, and olefin copolymers obtained by copolymerizing two or more kinds of monomer selected from the group consisting of olefins having from 2 to 10 carbon atoms. The olefin copolymer may be any of block copolymer, random copolymer and graft copolymer. Examples of ethylene polymer include low-density polyethylene, ultra low-density polyethylene, linear low-density polyethylene and high-density polyethylene. When the foamed layer contains such a thermoplastic resin, the content thereof is usually 10 wt % or less.

As the foaming agent for use in the formation of the foamed layer in the sheet of the present invention, any foaming agent selected from chemical foaming agents and physical foaming agents is available. Alternatively, foaming agents of both types may also be used in combination. The chemical foaming agents include known thermal decomposition-type foaming compounds such as thermal decomposition-type foaming agents which generate nitrogen gas [e.g. azodicarbonamide, azobisisobutylonitrile, dinitrosopentamethylene tetramine, p-toluenesulfonyl hydrazide, p,p′-oxy-bis(benzenesulfonyl hydrazide)] and thermal decomposition-type inorganic foaming agents which generate carbon dioxide gas (e.g. sodium hydrogencarbonate, ammonium carbonate, ammonium hydrogencarbonate). The physical foaming agents include propane, butane, water and carbon dioxide gas. Among the foaming agents provided above as examples, substances that are inactive with respect to a high-temperature condition or fire, such as water and carbon dioxide gas, are suitably employed. The amount of the foaming agent used may be determined appropriately depending upon the kinds of the foaming agent and the resin to be used so that a desired expansion ratio can be achieved. In usual, the foaming agent is used in an amount of 0.5 to 20 parts by weight per 100 parts by weight of propylene-based resin.

The sheet of the present invention has a non-foamed layer formed of a propylene-based resin that exhibits in its DSC measurement an endothermic curve that has a fusion peak which is the highest peak and which has a half-width ΔW of 15° C. or more. In other words, as previously mentioned, the inventive sheet has a non-foamed layer satisfying the DSC requirement.

The definition of the “highest peak” in an endothermic curve obtained by DSC measurement and the definition of the half-value width ΔW thereof are given below. The methods for determining the highest peak and the half-value width thereof are also described below.

For the DSC measurement, used is a sample which is cut out from a non-foamed layer of a propylene-based resin foamed sheet. This sample is set in a differential scanning calorimeter and is subjected to a thermal operation given below:
Stage (1): to increase the temperature from 30° C. to 200° C. at a rate of 10° C./min,
Stage (2): following Stage (1), to keep the temperature at 200° C. for 5 minutes,
Stage (3): following Stage (2), to decrease the temperature from 200° C. to 30° C. at a rate of 10° C./min,
Stage (4): following Stage (3), to keep the temperature at 30° C. for 5 minutes, and
Stage (5): following Stage (4), to increase the temperature from 30° C. to 200° C. at a rate of 10° C./min.

In Stage (5), an endothermic curve showing the relation of the quantity of heat absorbed (in ordinate) versus the temperature (in abscissa) is prepared.

When the endothermic curve has only one fusion peak, the peak is the “highest peak.” The length of a segment between the top of the peak and an intersection of the perpendicular dropped from the top to the abscissa and the baseline of the endothermic curve is defined as the “net height” of the peak.

When the endothermic curve has two or more fusion peaks, the “highest peak” refers to the peak whose “net height” defined in the same manner as mentioned above is the largest. Also in this case, the “net height” of the “highest peak” is defined in the same manner as above.

For the “highest peak” in both cases, the temperature width within which the endothermic curve is present on or above the level of the midpoint of the segment corresponding to the “net height” is defined as the “half-value width ΔW” as shown in FIG. 4.

The half-value width ΔW of the highest peak in the endothermic curve of a propylene-based resin indicates the melting point distribution of the propylene-based resin. From a propylene-based resin foamed sheet of the present invention which has a non-foamed layer that comprises a propylene-based resin having a ΔW of 15° C. or more, it is possible to produce a container of good appearance from the sheet in a wide temperature range by secondary molding such as vacuum forming. If the ΔW is smaller than 15° C., the processing temperature range where containers of good appearance can be produced will be narrow, resulting in a need to strictly control processing conditions. In light of the purpose of the present invention, it is desirable that the half-value width ΔW of the highest peak be as large as possible, but the half-value width ΔW is usually adjusted to a range of from 15° C. to 30° C.

In the present invention, the propylene-based resin foamed sheet is required only to have a non-foamed layer satisfying the DSC requirement as well as a foamed layer comprising propylene-based resin. The propylene-based resin of the non-foamed layer satisfying the DSC requirement may comprise only one kind of propylene-based resin or alternatively may comprise a composite of two or more kinds of resins wherein the composite exhibits in its DSC measurement an endothermic curve that has a fusion peak which is the highest peak in the curve and which has a half-value width ΔW of 15° C. or more.

In the production of the sheet of the present invention, as the propylene-based resin to be used for forming a non-foamed layer satisfying the DSC requirement, a propylene-based resin which is confirmed by DSC measurement before use that it exhibits in its DSC measurement an endothermic curve that has a fusion peak which is the highest peak and which has a half-value width ΔW of 15° C. or more or a composite of propylene-based resins that exhibits in its DSC measurement an endothermic curve that has a fusion peak which is the highest peak and which has a half-value width ΔW of 15° C. or more is chosen. The DSC measurement is conducted in a method including Stages (1) through (5) described previously. For preparing such a composite, propylene-based resins having different melting points are combined. Examples of such a combination of propylene-based resins include a combination of homopolypropylene and propylene-ethylene copolymer, and a combination of homopolypropylene and propylen-ethylene-butene terpolymer. When two kinds of propylene-based resins having different melting points are combined, the melting point difference is preferably 20° C. or more and the blending ratio in weight is preferably within the range of from 70/30 to 30/70. The propylene-based resin of a non-foamed layer satisfying the DSC requirement may be the same as or different from the propylene-based resin of the foamed layer. The non-foamed layer satisfying the DSC requirement may contain a resin other than propylene-based resin.

The propylene-based resin foamed sheet of the present invention is required only to have at least one foamed layer formed of propylene-based resin and at least one non-foamed layer satisfying the DSC requirement. In one embodiment, the sheet of the present invention has two or more non-foamed layers satisfying the DSC requirement. In another embodiment, the sheet of the present invention may have one or more non-foamed thermoplastic resin layers that do not satisfy the DSC requirement. The thermoplastic resin is not particularly restricted unless the properties given in the DSC requirement are satisfied. Examples thereof include propylene-based resin and saponified ethylene-vinyl ester copolymer.

Examples of the layer constitution of the propylene-based resin foamed sheet of the present invention include:
a constitution in which a foamed layer and a non-foamed layer are arranged alternately;
a constitution in which two or more non-foamed layers are formed on one side of a foamed layer; and
a constitution in which two or more foamed layers are formed on one side of a non-foamed layer.

An embodiment in which the propylene-based resin foamed sheet has a foamed layer formed of propylene-based resin having on its each side a non-foamed layer satisfying the DSC requirement is preferred because the sheet is superior in moldability and is suitable for producing containers of excellent appearance.

In an embodiment where the propylene-based resin foamed sheet has one or more non-foamed layers satisfying the DSC requirement and one or more non-foamed layers not satisfying the DSC requirement, it is desirable that the combined weight of the one or more non-foamed layers satisfying the DSC requirement account for 50% or more, more desirably 60% or more, of the combined weight of all the non-foamed layers including the two types of non-foamed layers. In this embodiment, if the weight proportion of the one or more non-foamed layers satisfying the DSC requirement is too less, the propylene-based resin foamed sheet tends to yield containers of poor appearance through its secondary molding.

The thickness of the sheet of the present invention is required only to be a thickness such that the sheet can be secondarily molded successfully by vacuum forming or the like. It is usually from 0.1 mm to 3 mm. In the propylene-based resin sheet comprising a foamed layer formed of propylene-based resin and a non-foamed layer satisfying the DSC requirement, the foamed layer and the non-foamed layer are not restricted in thickness, but the thickness of the foamed layer is preferably 0.1 mm or more and more preferably 0.3 mm or more from the viewpoint of heat insulating property. The thickness of the non-foamed layer is preferably from 1 μm to 200 μm and more preferably from 50 μm to 150 μm from the viewpoint of balance between strength and light weight property.

Each layer in the sheet of the present invention may contain additives. Examples of the additives include filler, antioxidants, light stabilizers, UV absorbers, plasticizers, antistatic agents, colorants, mold release agents, fluidizing agents and lubricants. In particular, incorporation of filler into a non-foamed layer is desirable because this can improve the rigidity, heat insulating property and the like of the sheet. Examples of the filler include inorganic fibers such as glass fiber and carbon fiber, and inorganic particles such as talc, clay, silica, titanium oxide, calcium carbonate and magnesium sulfate. In the case where talc is used, it is desirable that the talc have an average particle size within the range of 0.1 μm to 50 mμ from the viewpoints of secondary moldability of the sheet and effects of improving rigidity, heat insulating property and the like. Talc is preferably incorporated in a non-foamed layer in an amount of from 10 to 100 parts by weight per 100 parts by weight of the resin of the non-foamed layer.

The method for producing the sheet of the present invention is not particularly restricted. Preferably employed are methods in which a molten resin is extruded through a die such as a flat die (e.g. T die) and a circular die while being foamed and the extrudate is stretched and cooled on a mandrel or the like. In another embodiment, molten resin is extruded through a die and is cooled to solidify and then the solidified extrudate is subjected to stretching. Moreover, the following methods are also available: a method in which a layer or layers are formed on an extruded foamed sheet by extrusion lamination; a method in which a sheet is formed by sandwich lamination by melt extruding thermoplastic resin such as propylene-based resin between layers which are to be laminated; and a method in which layers are laminated after at least one surface of each layers is melted by heating by means of hot air or an infrared heater.

From the viewpoints of light weight property of a sheet to be produced and its production cost, particularly preferred is heat lamination described below. In the heat lamination, a foamed sheet and another layer are passed through nip rolls including two or more rolls; at a nipping section, hot air is blown from an air knife or the like to the laminating surface of at least one selected from the foamed sheet and another layer, thereby melting the surface; and then the foamed sheet and another layer are adhered through compression by the nip rolls.

The propylene-based resin foamed sheet of the present invention is superior in heat insulating property, light weight property and heat resistance. It, therefore, is suitable for use in the production of containers, e.g. cups, trays and bowls, for packaging foods or electronic parts by secondary molding such as vacuum forming, pressure forming and vacuum-pressure forming.

Examples of the method for producing a container by secondary molding the foamed sheet include methods in which a foamed sheet is heated to soften using an infrared heater or the like, and then shaping the softened sheet using a male mold, a female mole or paired male and female molds by secondary molding technique such as vacuum forming, pressure forming and vacuum-pressure forming. In the case where vacuum forming or vacuum-pressure forming is conducted using paired male and female molds or using a female mold and a plug having a form similar to a male mold, there is no need to bring the sheet into contact with the male mold or plug at the same time when bringing the sheet firmly into contact with the female mold. In other words, the sheet may be preliminarily shaped using the male mold before the female mold comes into contact with the sheet. In another method, the sheet is brought firmly into contact with the female mold and, immediately after that, it is shaped with the male mold. In yet another possible method, the sheet is blown by pressure against the female mold and simultaneously is sucked from the female mold, and finally the sheet is shaped by being pressed toward the female mold by means of the male mold or plug. The vacuum forming is preferred because it is less prone to damage the foamed layer and its products are resistant to deformation.

When the sheet of the present invention is shaped into a container, for example, by vacuum forming and is used as a food container or the like, it is desirable for the container to have a heat seal layer as its innermost layer. The heat seal layer desirably has easy peelability. One example of a heat seal layer with such a property is a layer formed of a resin composition comprising 100 parts by weight of thermoplastic resin and 0.5 to 160 parts by weight of fine particles having an average particle diameter of 0.05 μm to 20 μm selected from a group consisting of organic fine particles and inorganic fine particles. As the thermoplastic resin to be used for this purpose, a composite resin comprising 100 parts by weight propylene-based resin and 10 to 100 parts by weight of ethylene-based resin is preferred.

In addition, the container molded from the sheet of the present invention may be provided with an additional functional layer through application of a coating liquid.

The sheet of the present invention is superior in secondary moldability such as vacuum formability and containers of good appearance can be produced by molding of the sheet in a wide processing temperature range. The containers obtained from the sheet by vacuum forming have good appearance.

### EXAMPLES

The present invention will be described in more detail below with reference to examples. The invention, however, is not limited to the examples.

### EXAMPLE

In the way described below, a two-kind three-layer propylene-based resin foamed sheet was prepared. The sheet had a propylene-based resin foamed layer having on its each side a non-foamed layer satisfying the DSC requirement.

[I] Preparation of Pellets Of Propylene-Based Polymer

To 100 parts by weight of a propylene-based polymer which was composed of a higher molecular weight component and a lower molecular weight component and which was prepared according to the method disclosed in U.S. Pat. No. 6,110,986, 0.1 part by weight of calcium stearate, 0.05 part by weight of phenol-type antioxidant (available under the trade name Irganox 1010 from Ciba Specialty Chemicals Corp.) and 0.2 part by weight of phenol-type antioxidant (available under the tradename Sumilizer BHT from Sumitomo Chemical Co., Ltd.) were added and mixed. The mixture was kneaded at 230° C. to yield propylene-based polymer pellets [1] having a melt flow rate (MFR) or 4.5 g/10 min (230° C., 2.16 kgf).

The properties of the propylene-based polymer are as follows:
The higher molecular weight component:
   Intrinsic viscosity [η]_{A}=9.5 dl/g
   Ethylene content (C2_{inA})=2.9%
The lower molecular weight component:
   Intrinsic viscosity. [η]_{B}=11 dl/g
   Ethylene content (C2_{inB})=2.7%

Uniaxial melt elongation viscosity determined at 180° C. using a uniaxial melt elongation viscosity analyzer manufactured by Rheometrics Scientific, Inc.
η₅=300,000 Pa·s
η_{0.1}=2,900 Pas
   [II] Preparation of Material for Foamed Layer

Three ingredients [1], [2] and [3] listed below were dry blended in a weight ratio [1]/[2]/[3]=70/21/9 to yield a material for forming a foamed layer.
[1]: Propylene-based polymer pellets prepared above
[2]: Polypropylene 1 (Homopolypropylene R101 manufactured by Sumitomo Chemical Co., Ltd.; melting point=164° C.; MFR (230° C., 2.16 kgf)=20 g/10 min)
[3]: Polypropylene 2 (Homopolypropylene U101E9 manufactured by Sumitomo Chemical Co., Ltd.; melting point=164° C.; MFR (230° C., 2.16 kgf)=120 g/10 min)
   [III] Preparation of Material for Non-Foamed Layers

Five ingredients [4], [5], [6], [7] and [8] listed below were dry blended in a weight ratio [4]/[5]/[6]/[7]/[8]=21/30/20/29/5 to yield a material for forming non-foamed layers.
[4]: Polypropylene 3 (Homopolypropylene FS2011DG2 manufactured by Sumitomo Chemical Co., Ltd.; melting point=158° C.; MFR (230° C., 2.16 kgf)=2.5 g/10 min)
[5]: Polypropylene 4 (Propylene-ethylene-butene copolymer W171 manufactured by Sumitomo Chemical Co., Ltd.; monomer weight ratio: propylene/ethylene/butene=92.4/4.0/3.6; melting point=129° C.; MFR (230° C., 2.16 kgf)=6 g/10 min)
[6]: Polypropylene 5 (Long-chain branching homopolypropylene PF814 manufactured by Montell; melting point=164° C.; MFR (230° C., 2.16 kgf)=3 g/10 min)
[7]: Talc masterbatch (Polypropylene-talc masterbatch MF110 manufactured by Sumitomo Chemical Co., Ltd.; talc content=70 wt %; melting point of propylene-based polymer matrix=164° C.)
[8]: Titanium oxide masterbatch (Polyethylene-titanium oxide masterbatch SPEM7A1155 manufactured by Sumika Color Co., Ltd.; titanium oxide content=60 wt %)
   [IV] Production of Propylene-Based Resin Foamed Sheet

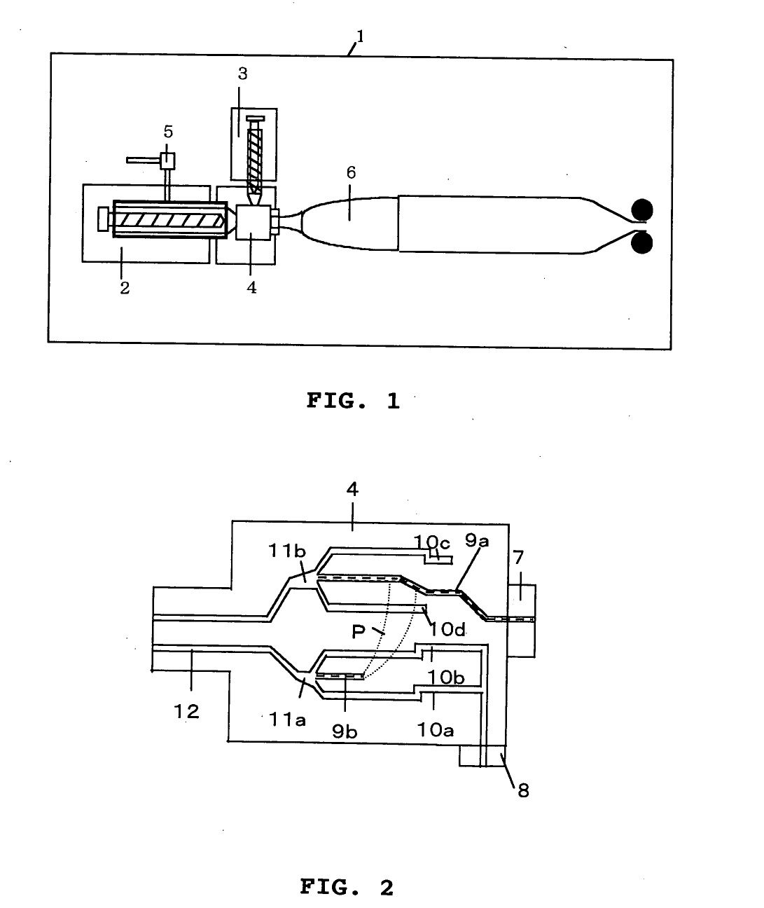

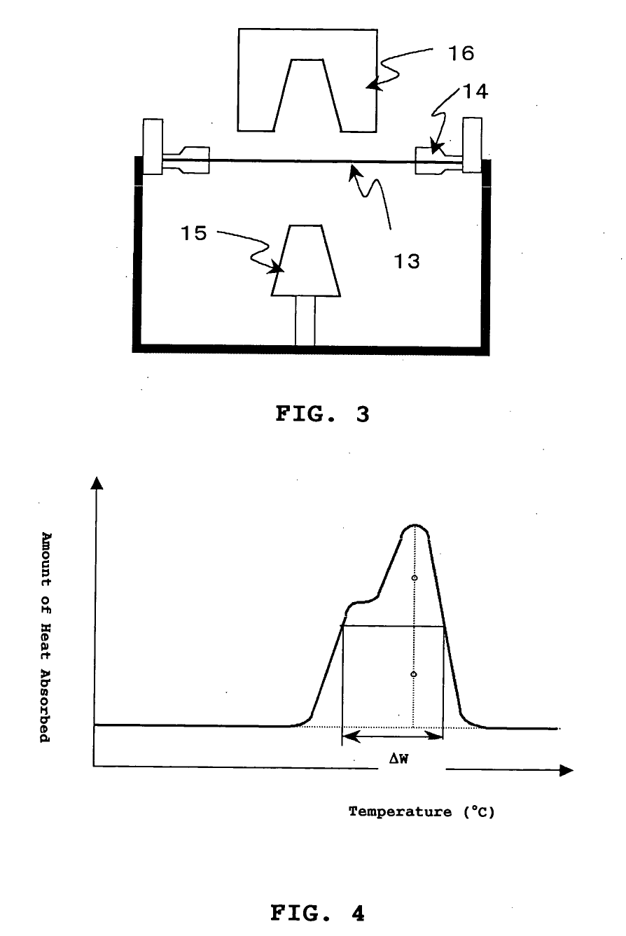

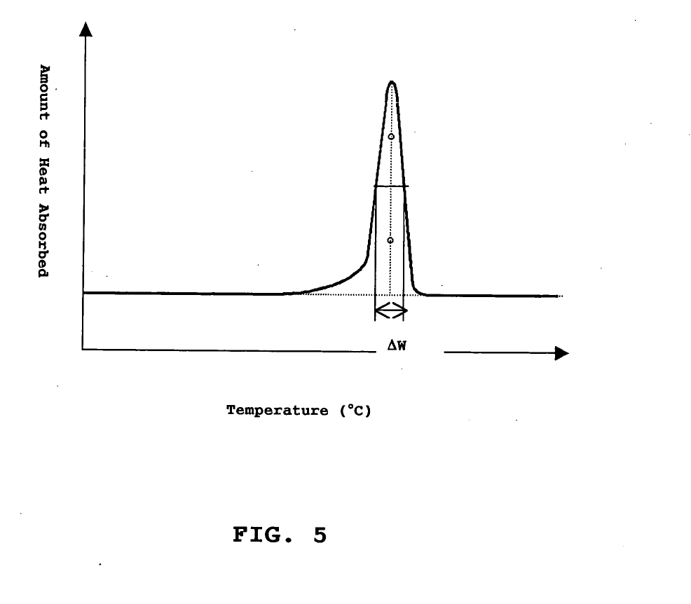

A sheet manufacturing machine schematically shown in FIGS. 1 and 2 was prepared. In FIGS. 1 and 2, items indicated by numerals are as follows:

| | |
|---|---|
| 1: | Sheet manufacturing machine; |
| 2: | Twin screw extruder (50 mmφ) |
| 3: | Single screw extruder (32 mmφ) |
| 4: | Circular die (90 mmφ) |
| 5: | Pump of supplying carbon dioxide gas |
| 6: | Mandrel |
| 7: | Head of twin screw extruder (50 mmφ) |
| 8: | Head of single screw extruder (32 mmφ) |
| 9a: | Passageway |
| 9b: | Passageway |
| 10a: | Passageway |
| 10b: | Passageway |
| 10c: | Passageway |
| 10d: | Passageway |
| 11a: | Lamination zone (Passageway) |
| 11b: | Lamination zone (Passageway) |
| 12: | Circular die outlet |
| 13: | Sheet |
| 14: | Clip |
| 15: | Plug |
| 16: | Female mold |

A propylene-based resin foamed sheet composed of two non-foamed layer and a foamed layer interposed between the non-foamed layers was produced by extrusion forming using a sheet manufacturing machine (1) equipped with a twin screw extruder (50 mmφ) (2) for extruding the foamed layer, a single screw extruder (32 mmφ) (3) for extruding the non-foamed layers and a circular die (90 mmφ). In the production, the material for forming the foamed layer and the material for forming the non-foamed layers prepared in Sections [II] and [III] above were used.

A blend material obtained by blending 100 parts by weight of the material for forming the foamed layer and 2 parts by weight of nucleating agent (available under the trade name Hydrocerol from Baylinger Ingelhyme Chemicals) was fed into the twin screw extruder (2) through a hopper. It was kneaded in a cylinder heated to 180° C.

When the material for forming the foamed layer and the nucleating agent had been melt-kneaded fully to be compatibilized together and the nucleating agent had been thermally decomposed to foam in the twin screw extruder (2), 1 part by weight of carbon dioxide gas as a physical foaming agent was poured from a pump (5) connected to a liquefied carbon dioxide cylinder. After the pouring of carbon dioxide gas, the kneaded material was impregnated with the carbon dioxide gas through a further kneading and then fed to the circular die (4).

The material for forming the non-foamed layers was melt-kneaded in the single screw extruder (3) and then fed to the circular die (4).

In the circular die (4), the material for forming the foamed layer introduced into the die through a head (7) of the twin screw extruder (2) was transmitted toward the outlet of the die through a passageway (9a). On the midway in the passageway (9a), the material was divided through a path P and transmitted also to a passageway (9b). The material for forming the non-foamed layers was introduced into the die through a head (8) of the single screw extruder and then divided into passageways (10a) and (10b). After the division, the material was transmitted toward the outlet of the die while being supplied so as to be laminated on both sides of the passageway (9b). In a lamination zone (11a), the lamination was achieved. The material for forming the non-foamed layers, which was supplied into the passageways (10a) and (10b), was divided and transmitted into passageways (10c) and (10d) through branching paths (not shown) similar to the path P. Then the material was transmitted toward the outlet of the die while being supplied so as to be laminated on both sides of the passageway (9a). In a lamination zone (11b), the lamination was achieved. The molten resin fabricated into a tubular two-kind three-layer structure in the lamination zones (11a) and (11b) was extruded through the outlet (12) of the circular die (4). The release of the tubular resin to atmospheric pressure allowed the carbon dioxide gas contained in the material for forming the foamed layer to expand to form bubbles. Thus, the layer of the material for forming the foamed layer was caused to foam. As a result, a two-kind three-layer propylene-based resin foamed sheet having a thickness of 1.2 mm was obtained.

The two-kind three-layer foamed sheet extruded through the die was stretched and cooled while being drawn over a mandrel (6) having a maximum diameter of 210 mm to form a tube. The resulting tubular foamed sheet was slit longitudinally into one 660-mm wide flat sheet, which was then drawn up around a draw-up roll.

Using the propylene-based resin foamed sheet prepared in the manner mentioned above, a container was produced by vacuum forming. In the vacuum forming, a commercially available vacuum forming machine (WPB1200 manufactured by fu-se Vacuum Forming) was used.

First, the propylene-based resin foamed sheet (13) was clamped with clips (14) as shown in FIG. 3 and was heated with an infrared heater (not shown) so that the surface of the sheet came to a temperature of 160° C.

Then, a plug (15) was moved to the sheet to come into contact therewith. The plug was further moved perpendicularly against the sheet toward a female mold (16) arranged beyond the sheet. Thus, the sheet was brought into contact with the surface of the female mold to be preliminarily shaped into a container shape.

Following the contact with the female mold's surface, the sheet was sucked from the female mold to come into firm contact with the mold. Thus, the sheet was shaped so as to have a configuration corresponding exactly to the shape of the female mold's surface.

Thereafter the shaped sheet was solidified by air-cooling with a fan, was released from the clips, and was removed from the female mold.

When the edge of the sheet was trimmed, a container was obtained which had an opening diameter of 130 mm, a flange width of 10 mm, a bottom diameter of 60 mm and a height of 50 mm.

The propylene-based resin foamed sheet and the container vacuum-formed therefrom were evaluated; the results are shown in Tables 1 and 2.

### COMPARATIVE EXAMPLE

A propylene-based resin foamed sheet was prepared in the same manner as Example described above except using a material for forming non-foamed layers shown below. Subsequently, a container was produced from the sheet by vacuum forming. The sheet and the container were evaluated; the results are given in Tables 1 and 2.

[Preparation of Material for Non-Foamed Layers]

Four ingredients [4], [9], [7] and [8] listed below were dry blended in a weight ratio [4]/[9]/[7]/[8]=24/47/29/5 to yield a material for forming non-foamed layers.
[4]: Polypropylene 3
[9]: Polypropylene 6 (Homopolypropylene W101 manufactured by Sumitomo Chemical Co., Ltd.; melting point=164° C.; MFR (230° C., 2.16 kgf)=8 g/10 min)
[7]: Talc masterbatch
[8]: Titanium oxide masterbatch
   (Measurement of Expansion Ratio)

Using an immersion-type density meter (automatic densimeter,D-H100 manufactured by Toyo Seiki Seisaku-sho, Ltd.), a piece of propylene-based resin foamed sheet cut into a size of 20 mm×20 mm was measured for its specific density. Moreover, the expansion ratio was calculated using the densities of the materials forming the foamed sheet.

(Determination of Half-Value Width)

A differential scanning calorimeter (DSC220 manufactured by Seiko Instruments Inc.) was used. A sample of about 10 mg was set in the analyzer and was subjected to a thermal operation including five stages shown below. Thus, an endothermic curve indicating the relation of the quantity of heat absorbed (in ordinate) versus the temperature (in abscissa) was obtained.
Stage (1): to increase the temperature from 30° C. to 200° C. at a rate of 10° C./min,
Stage (2): following Stage (1), to keep the temperature at 200° C. for 5 minutes,
Stage (3): following Stage (2), to decrease the temperature from 200° C. to 30° C. at a rate of 10° C./min,
Stage (4): following Stage (3), to keep the temperature at 30° C. for 5 minutes, and
Stage (5): following Stage (4), to increase the temperature from 30° C. to 200° C. at a rate of 10° C./min.

Using the endothermic curve, a “highest peak” and a half-value width ΔW thereof were determined in the way previously described.

(Determination of Vacuum Forming Temperature Range)

A temperature range where a sheet can be vacuum-formed successfully was determined. In the determination, vacuum forming was performed repeatedly while adjusting the time of heating using an infrared heater, thereby varying the sheet surface temperature during the vacuum forming. At each temperature, whether vacuum forming was achieved successfully or not was checked through an observation of the appearance of the shaped product. The sheet surface temperature was determined with a thermocouple attached to the sheet surface. A surface temperature detected just before vacuum forming was used as the surface temperature during the vacuum forming.

The shaped products were visually observed and evaluated for their appearance using the criteria shown below:
Rating: Criterion
   A: The molded product has a good appearance.
   B: The molded product has a shape corresponding exactly to the mold used, but it has a rough surface with lots of irregularities.
   C: The molded product does not have a shape corresponding exactly to the mold used.

A temperature range where rating a was achieved was determined as a “vacuum forming temperature range.”

TABLE 1

| | | Comparative |
|---|---|---|
| | Example | Example |
| Weight of foamed layer | 59 | 59 |
| Weight of non-foamed layer | 41 | 41 |
| Expansion ratio of foamed layer | 3.0 | 3.0 |
| Half-value width ΔW | 17 | 9 |
| Vacuum forming temperature range | 18 | 10 |

TABLE 2

| | Surface temperature (° C.) | | | | | | | | |
|---|---|---|---|---|---|---|---|---|---|
| | 133 | 135 | 138 | 140 | 145 | 150 | 155 | 158 | 160 |
| Example | C | B | A | A | A | A | A | B | C |
| Comparative | C | C | C | B | A | A | A | B | C |
| Example | | | | | | | | | |

1. A propylene-based resin foamed sheet comprising a foamed layer formed of propylene-based resin and a non-foamed layer formed of a propylene-based resin that exhibits in its DSC measurement an endothermic curve that has a fusion peak which is the highest peak in the curve and which has a half-width ΔW of 15° C. or more.

2. The propylene-based resin foamed sheet according to claim 1, wherein the foamed layer has on its each side a non-foamed layer formed of a propylene-based resin that exhibits in its DSC measurement an endothermic curve that has a fusion peak which is the highest peak in the curve and which has a half-width ΔW of 15° C. or more.

3. A container obtained by vacuum forming the propylene-based resin foamed sheet according to claim 1 or 2.
